(19) United States
(12) Patent Application Publication
(10) Pub. No.: US 2013/0100966 A1
(43) Pub. Date: Apr. 25, 2013

(54) SYSTEM FOR TRANSFERRING ELECTRIC POWER AND SIGNALS VIA POWER LINE BY TIME-DIVISION MULTIPLEXING

(71) Applicants: Chun-Ming Huang, Hsinchu City (TW); Chien-Ming Wu, Hsinchu City (TW); Gang-Neng Sung, Hsinchu City (TW)

(72) Inventors: Chun-Ming Huang, Hsinchu City (TW); Chien-Ming Wu, Hsinchu City (TW); Gang-Neng Sung, Hsinchu City (TW)

(73) Assignee: National Chip Implementation Center National Applied Research Laboratories, Hsinchu City (TW)

(21) Appl. No.: 13/308,611

(22) Filed: Dec. 1, 2011

(30) Foreign Application Priority Data
Oct. 25, 2011 (TW) 100138744

(51) Int. Cl. H04J 3/06

(52) U.S. Cl. 370/503

(57) ABSTRACT

A system for transferring electric power and signals via a power line by time-division multiplexing includes a power line, electronic-circuit units, and controllers. The power line includes a first transmission line and a second transmission line. The first transmission line is connected with a first switch in series and is therefore divided into a source end and a loading end. The electronic-circuit units are connected in series between the loading end and the second transmission line. The controllers are electrically connected with and are configured for synchronously controlling the first switch and the electronic-circuit units. When the first switch is closed, electric power is transferred from an electric power source to the loading end, and when the first switch is opened, the electronic-circuit units transfer signals via the loading end. The system features simple circuitry and effectively reduces noise in signal transmission.

### BACKGROUND OF THE INVENTION

1. Technical Field

The present invention relates to a system for transferring electric power and signals via a power line by time-division multiplexing. More particularly, the present invention relates to a system which uses the time-division multiplexing technique to transfer electric power and signals through a direct-current (DC) or alternating-current (AC) power line.

2. Description of Related Art

FIG. 1A shows the waveforms of electric power signals and communication signals in a conventional power-line communication system, before and after signal modulation. FIG. 1B is a flowchart of the communication process of a conventional power-line communication system. Referring to FIGS. 1A and 1B, a conventional power-line communication system uses a modulation circuit 13 to modulate the communication signals 11 in the original data and then mixes the modulated communication signals 11 with the electric power signals 10, so as for the power line 14 to transfer the mixed signals 12, i.e., the mixture of the modulated communication signals 11 and the electric power signals 10. Once reaching the receiving end, the mixed signals 12 are filtered by a filter 15 to extract the modulated communication signals 11, which are subsequently demodulated by a demodulation circuit 16 to restore the original data. Thus, power transfer and signal transmission are simultaneously achieved via the power line 14.

As the communication signals 11 are mixed with the electric power signals 10 by modulation and are transferred through the power line 14, the communication signals 11 are very likely to be affected by noise in the electric power signals 10. Moreover, the communication performance is often compromised by the fact that different types of electronic devices have different impedances when connected with the power line 14, and that impedance variation resulting from turning on or off the electronic devices as well as attenuation of the communication signals 11 during transmission also varies from device to device.

The major drawback of transferring both the communication signals 11 and the electric power signals 10 via the same power line 14 using the modulation technique is this: the communication signals 11 tend to generate noise under the influence of the electric power signals 10, even to such extent that the communication signals 11 are distorted. If the communication signals 11 are control signals, erroneous actions will ensue. Therefore, it is important to prevent the communication signals 11 from being interfered by the electric power signals 10 when both are transferred through the power line 14.

### BRIEF SUMMARY OF THE INVENTION

The present invention relates to a system for transferring electric power and signals via a power line by time-division multiplexing, wherein the system includes a power line, electronic-circuit units, and controllers. The major object of the present invention is to apply the time-division multiplexing technique and protect communication signals from interference by electric power signals that are transferred through the same power line as the communication signals, with a view to effectively lowering noise in the communication signals.

The present invention provides a system for transferring electric power and signals via a power line by time-division multiplexing. The system includes a power line, at least two electronic-circuit units, and at least one controller. The power line includes a first transmission line and a second transmission line. The first transmission line is connected with a first switch in series such that the first transmission line is divided into a source end and a loading end. Each electronic-circuit unit is connected in series between the loading end and the second transmission line. The at least one controller is electrically connected with and configured for synchronously controlling the first switch and the electronic-circuit units. When the first switch is closed, electric power is transferred from an electric power source to the loading end, and when the first switch is opened, the electronic-circuit units transfer signals via the loading end.

Implementation of the present invention at least involves the following inventive steps:

1. Communication signals and electric power signals are respectively transferred in different time intervals to prevent mutual interference and effectively reduce noise.

2. The loading end of the power line can be directly used as a transmission line to eliminate the need for an additional signal communication line; hence, the circuitry of the system is made simple.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1A shows the waveforms of electric power signals and communication signals in a conventional power-line communication system, before and after signal modulation;

FIG. 1B is a flowchart of the communication process of a conventional power-line communication system;

FIG. 2A shows an embodiment of implementing a system for transferring electric power and signals via a DC power line in accordance with the present invention;

FIG. 2B shows how electric power is directly supplied from an electric power source to a major electronic-circuit unit in accordance with an embodiment of the present invention;

FIG. 3 shows another embodiment of implementing a system for transferring electric power and signals via a DC power line in accordance with the present invention;

FIG. 4 is the time sequence diagram of various embodiments of the present invention;

FIG. 5 shows a system with energy storage elements in accordance with an embodiment of the present invention; and

FIG. 6 shows a system for transferring electric power and signals via an AC power line in accordance with an embodiment of the present invention.

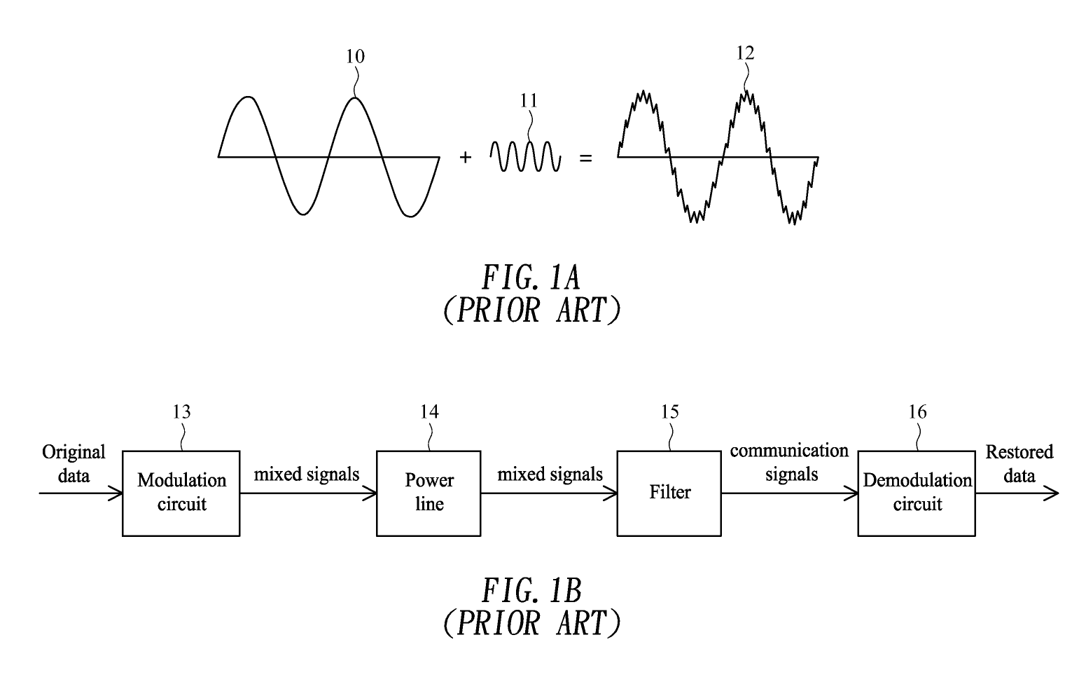

### DETAILED DESCRIPTION OF THE INVENTION

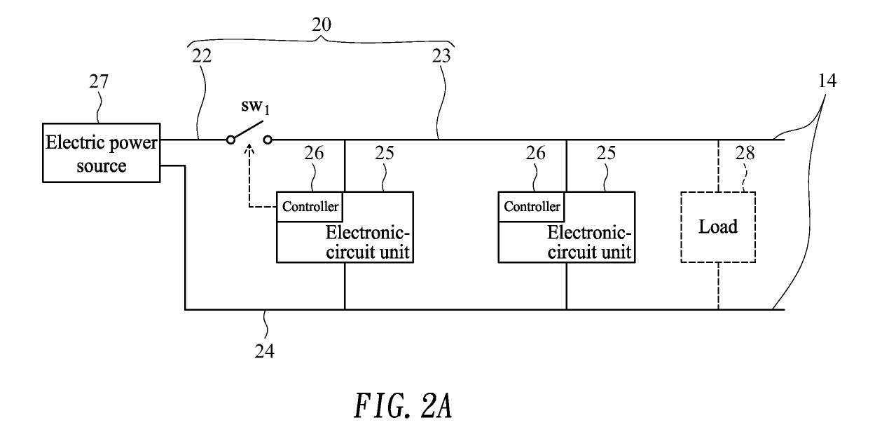

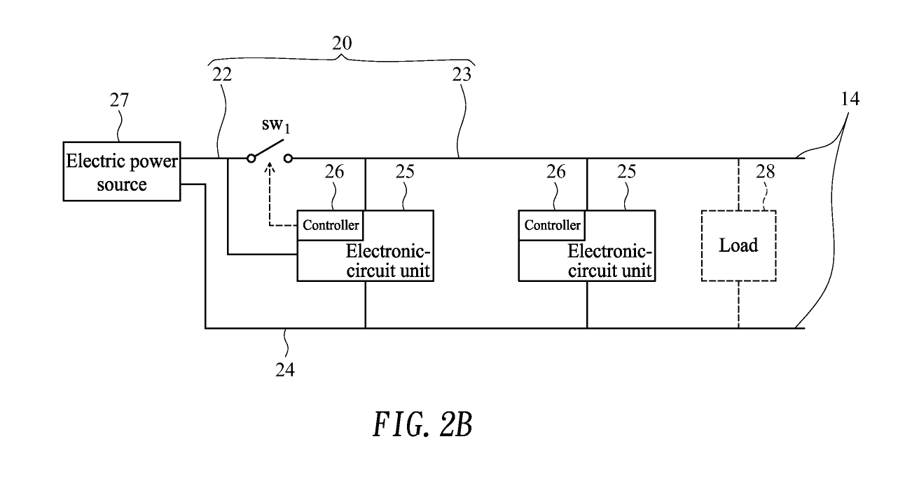

Referring to FIG. 2A for an embodiment of the present invention, a system for transferring electric power and signals via a power line by time-division multiplexing includes a power line 14, at least two electronic-circuit units 25, and at least one controller 26.

The power line 14 includes a first transmission line 20 and a second transmission line 24. The power line 14 can be a DC power line. In that case, the first transmission lines 20 can be a positive-electrode power line while the second transmission line 24 is a negative-electrode power line or a ground line. The first transmission line 20 is connected with a first switch SW₁ in series; thus, the first transmission line 20 is divided into a source end 22 and a loading end 23. The loading end 23 serves to transfer electric power when the first switch SW₁ is closed, and the loading end 23 serves to transfer signals when the first switch SW₁ is opened.

The electronic-circuit units 25 can be various devices having input/output functions, such as sensors in a security system or detectors in a vehicular electronic system. As for circuit arrangement, each electronic-circuit unit 25 is connected in series between the loading end 23 of the first transmission line 20 and the second transmission line 24. In addition, at least one load 28 can be connected in series between the loading end 23 and the second transmission line 24. As the electronic-circuit units 25 are arranged in a distributed manner, they can be powered by dry-cell batteries as appropriate.

The at least one controller 26 is provided in the electronic-circuit units 25 in a one-to-one manner. Of all the electronic-circuit units 25, the one closest to the first switch SW₁ is defined as the major electronic-circuit unit 25. The controller 26 in the major electronic-circuit unit 25 not only controls the operation of the major electronic-circuit unit 25 itself, but also controls the operation of the first switch SW₁ simultaneously, so as for the first switch SW₁ to work in synchronization with all the electronic-circuit units 25. To synchronize all the controllers 26, the time of each controller 26 is automatically checked upon system initialization, thus allowing the controllers 26 to control the electronic-circuit units 25 and the first switch SW₁ individually and synchronously based on the same time reference.

Referring to FIG. 2B, in order to stabilize the electric power supplied to the major electronic-circuit unit 25 or simplify the circuit thereof, the power input end of the major electronic-circuit unit 25 is electrically and directly connected with the source end 22. Thus, electric power can be supplied to the major electronic-circuit unit 25 directly from an electric power source 27.

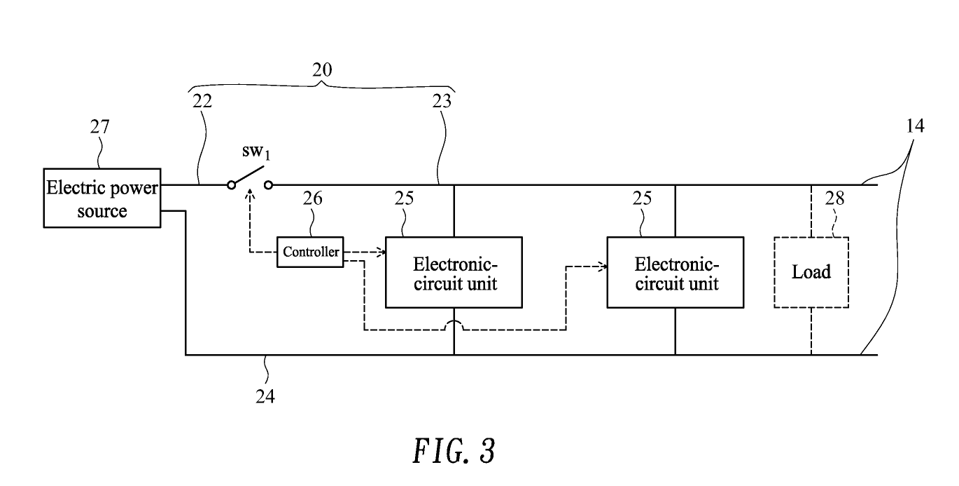

With reference to FIG. 3, apart from the foregoing implementation mode in which the at least one controller 26 is provided in the electronic-circuit units 25 in a one-to-one manner, the system can be configured in such a way that a single controller 26 is electrically connected with and configured for synchronously controlling the first switch SW₁ and each electronic-circuit unit 25. In this way, not only is the first switch SW₁ operable in synchronization with all the electronic-circuit units 25, but also the circuitry of the system is simplified.

Reference is now made to FIGS. 2A to 4, particularly to those parts related to the first switch SW₁, the electric power signals, and the communication signals. When the first switch SW₁ is closed by the controller 26 in charge, the electric power source 27 supplies electric power to the loading end 23. When the first switch SW₁ is subsequently opened by the controller 26, the electrical connection between the loading end 23 and the electric power source 27 is cut off. As a result, the electric power source 27 stops supplying electric power to the load 28 at the loading end 23, and the electronic-circuit units 25 can now transmit signals via the loading end 23. Since electric power and signals are respectively transmitted during different time intervals and are completely isolated from each other by the first switch SW₁, the electric power signals are prevented from interfering with the communication signals, and noise in signal transmission is effectively reduced.

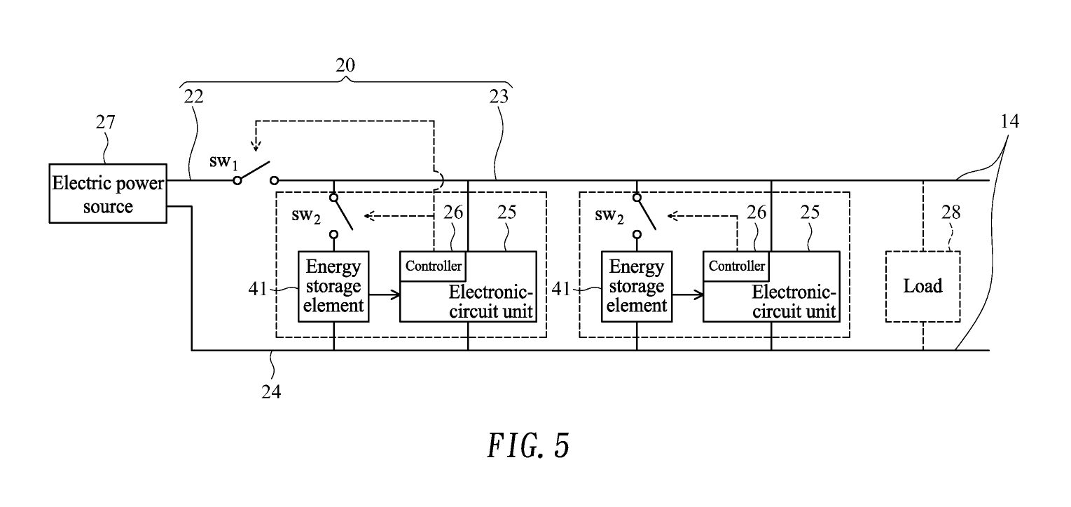

Referring to FIG. 5, in order to utilize the electric power supplied through the power line 14, the foregoing embodiments of implementing the present invention may further include connecting each electronic-circuit unit 25 in parallel with a second switch SW₂ and an energy storage element 41, wherein the second switches SW₂ and the energy storage elements 41 are sequentially connected in series between the loading end 23 and the second transmission line 24. The second switches SW₂ prevent the energy storage elements 41 from unnecessary discharge during transmission of communication signals. The energy storage elements 41, on the other hand, provide the electric power required for operation of the corresponding electronic-circuit units 25. Each energy storage element 41 can be a rechargeable battery, a capacitor, a plurality of series-connected capacitors, or a plurality of parallel-connected capacitors Likewise, the at least one controller 26 can be provided in the electronic-circuit units 25 in a one-to-one manner and electrically connected with the first switch SW₁ and the second switches SW₂ so as to control the first switch SW₁ and the second switches SW₂ synchronously.

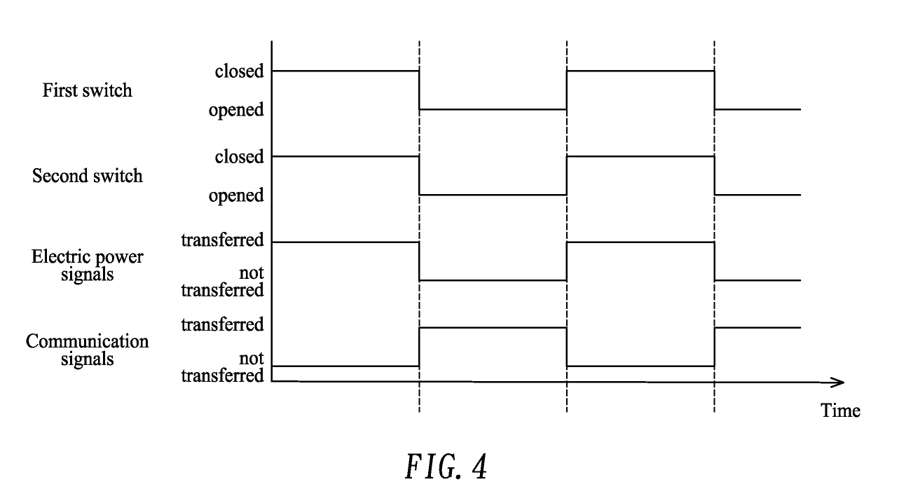

Referring to FIGS. 4 and 5, when both the first switch SW₁ and the second switches SW₂ are closed, the electric power source 27 transfers electric power to the load 28 at the loading end 23 and charges the energy storage elements 41. When both the first switch SW₁ and the second switches SW₂ are opened, the electrical connection between the load 28 at the loading end 23 and the electric power source 27 is cut off such that the electric power source 27 stops transferring electric power to the load 28 at the loading end 23 and stops charging the energy storage elements 41. Thus, the electronic-circuit units 25 are allowed to transfer signals through the loading end 23 while the energy storage elements 41 provide the necessary electric power for operating the electronic-circuit units 25.

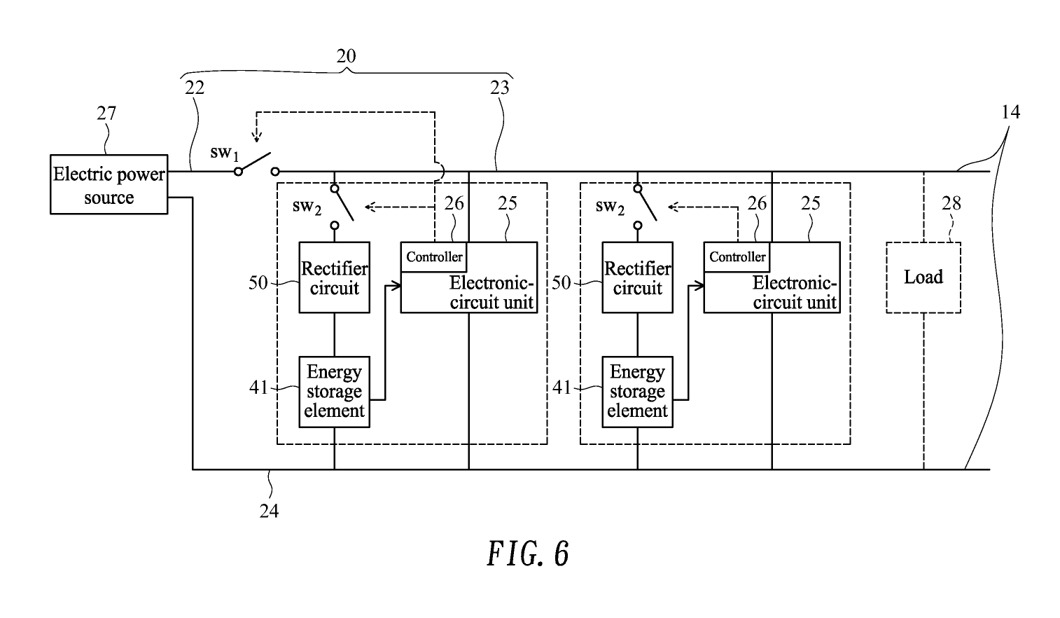

Referring to FIG. 6, when the power line 14 is an AC power line, with the electric power source 27 being an AC electric power source, the first transmission line 20 is generally known as the live line, and the second transmission line 24 as the neutral line. A rectifier circuit 50 is connected in series between each second switch SW₂ and the corresponding energy storage element 41 so as to convert AC electric power into DC electric power. Each rectifier circuit 50 can be a bridge rectifier circuit.

As shown in FIGS. 4 and 6, when both the first switch SW₁ and the second switches SW₂ are closed, the electric power source 27 transfers electric power to the load 28 at the loading end 23. As for the energy storage elements 41, the AC electric power output from the electric power source 27 is first converted into DC electric power by the rectifier circuits 50 and then used to charge the energy storage elements 41. When both the first switch SW₁ and the second switches SW₂ are opened, the electric power source 27 stops transferring electric power to the load 28 at the loading end 23 or the rectifier circuits 50 and stops charging the energy storage elements 41, and the electronic-circuit units 25 can transmit signals through the loading end 23 during such time intervals, with the electric power provided by the energy storage elements 41.

In the embodiments described above, signal transmission is carried out via the loading end of the power line by using the time-division multiplexing technique, so the need for an additional line dedicated to signal transmission is eliminated. In other words, the circuitry of the system is made simple As the time-division multiplexing technique allows the system to transfer electric power and signals in different time intervals respectively, communication signals are protected from interference by electric power signals. Also, noise or impedance variation caused by turning on or off the devices connected with the power line is prevented from hindering the transmission of communication signals. Consequently, noise in signal transmission is effectively lowered, and the quality of signal transmission is enhanced.

The features of the present invention are disclosed above by the preferred embodiment to allow persons skilled in the art to gain insight into the contents of the present invention and implement the present invention accordingly. The preferred embodiment of the present invention should not be interpreted as restrictive of the scope of the present invention. Hence, all equivalent modifications or amendments made to the aforesaid embodiment should fall within the scope of the appended claims.

What is claimed is:

1. A system for transferring electric power and signals via a power line by time-division multiplexing, comprising:
a power line comprising a first transmission line and a second transmission line, wherein the first transmission line is connected in series with a first switch and is thus divided into a source end and a loading end;
at least two electronic-circuit units, each connected in series between the loading end and the second transmission line; and
at least a controller electrically connected with and configured for synchronously controlling the first switch and the electronic-circuit units, wherein when the first switch is closed, electric power is transferred from an electric power source to the loading end, and when the first switch is opened, the electronic-circuit units transfer signals through the loading end.

2. The system of claim 1, wherein the power line is a direct-current (DC) power line or an alternating-current (AC) power line.

3. The system of claim 1, wherein a said electronic-circuit unit is defined as a major electronic-circuit unit, and the major electronic-circuit unit has a power input end electrically connected with the source end.

4. The system of claim 1, wherein the at least a controller is provided in the electronic-circuit units in a one-to-one manner.

5. The system of claim 1, wherein at least one of the electronic-circuit units is connected in parallel with a second switch and an energy storage element, and the at least one second switch and the at least one energy storage element are sequentially connected in series between the loading end and the second transmission line, the at least a controller being electrically connected with and configured for synchronously controlling the at least one second switch, wherein when the at least one second switch is closed, the electric power source transfers electric power to the loading end and charges the at least one energy storage element, and when the at least one second switch is opened, the at least one energy storage element provides electric power required for operation of the at least one of the electronic-circuit units.

6. The system of claim 5, wherein a rectifier circuit is connected in series between each said second switch and a corresponding said energy storage element when the power line is an AC power line.

7. The system of claim 6, wherein each said energy storage element is one of a rechargeable battery, a capacitor, a plurality of series-connected capacitors, and a plurality of parallel-connected capacitors.
